(19) United States
(12) Patent Application Publication
(10) Pub. No.: US 2026/0076284 A1
(43) Pub. Date: Mar. 19, 2026

(54) PRECISION AGRICULTURE USING SCENE MATCHING

(71) Applicant: DEERE & COMPANY, MOLINE, IL (US)

(72) Inventor: Eric Taipale, St. Paul, MN (US)

(21) Appl. No.: 19/286,457

(22) Filed: Jul. 31, 2025

Related U.S. Application Data
(60) Provisional application No. 63/695,936, filed on Sep. 18, 2024.

(51) Int. Cl. A01B 79/00; A01B 79/02; A01M 21/04; G06V 10/62; G06V 20/10; G06V 20/17; G06V 20/56

(52) U.S. Cl. CPC A01B 79/005; A01B 79/02; A01M 21/04; G06V 10/62; G06V 20/17; G06V 20/188; G06V 20/56

(57) ABSTRACT

Methods and systems for use in precision agriculture that use scene comparison to determine a match between a current captured scene by a scene capture system on a precision agriculture machine and an off-platform previously captured scene captured by an off-platform scene capture system separate from the precision agriculture machine. The scenes include at least one item of interest and one or more additional features. When a match between scenes is determined, the precision agriculture machine is used to take an action that impacts the at least one item of interest in the agricultural field.

### CROSS-REFERENCE TO RELATED APPLICATIONS

This application claims the benefit of U.S. Provisional Application No. 63/695,936, filed on 18 Sep. 2024, the disclosure of which is incorporated by reference.

### FIELD

The technology described herein relates to precision agriculture.

### BACKGROUND

In agriculture, many different types of field activities are performed on an area in which crops are grown or harvested, such as a field, plot, pasture, or orchard. The field activities may include plowing and soil preparation; planting seeds, seedlings, or small plants; application of chemicals (herbicides, insecticides, fungicides, fertilizers, application of other biological and non-biological fertility and crop protection products); establishing optimal harvest timing; harvesting crops; non-chemical means of removing weeds and undesired plants including mechanical and manual removal; and post-harvest and pre-planting treatments, including tillage and cover cropping. Field activities are often preceded by one or more field observations that inform the need for a certain field activity, influence the configuration of the field activity, or establish an optimal time to perform the field activity. For example, a decision to apply herbicide may be informed by an observation indicating the presence of weeds, their type, and population.

The field of precision agriculture may be broadly defined as the performance of more granular, “fine-grained” variants of field activities based on more temporally and/or spatially granular data. For example, instead of applying weed-killing chemicals at a uniform rate to an entire field, the rate and mode of application could be varied to only apply certain chemicals to areas where weeds exist if the locations of those weeds can be determined, and/or to customize different chemicals or products to address different types of weeds. As another example of precision agriculture practices, instead of planting seeds at a uniform spatial distribution across an entire field, the use of soils data or other information could allow for a variable planting rate that could yield greater profit by planting crops more densely in higher-performing parts of the field.

There are many other example applications of precision agriculture that follow this general pattern. In general, an item of interest exists in the field. In the practice of managing weeds, the item of interest is a weed. In the practice of managing fungal pressure, the item of interest is a plant or soil area upon which a fungus is present. In the practice of managing insect pressure, the item of interest is a plant or soil area upon which an insect infestation is occurring. In all cases, the item of interest must be detected and spatially resolved, in a relative or absolute sense, to allow some management action to take place with an appropriate degree of selectivity.

An important task in performing more spatially granular field activities lies in the geospatial registration of the field activity with the data observations that inform the field activity, which characterizes the items of interest. For example, in the previous weed control example, the weed must be detected and this information must be coordinated with an action mechanism that eliminates the weed because on its own the action mechanism is not aware of the presence or the location of the weed.

Precision application systems for agriculture exist that employ scene capture and scene analysis systems (collectively referred to as a detection mechanism) mounted on a farm machine. The scene capture system captures scenes/images of the field, and the scene analysis system analyzes the captured scenes/images to detect the weed(s) in the captured scenes/images. Once the weeds are detected, commands are issued commanding the application of herbicides, using an action mechanism, to detected weeds at the correct time and configuration to apply herbicide at the locations of the detected weeds. When this known system operates properly, herbicide is not directed to areas in which weeds are not present and is applied to areas in which weeds are present, generating potential cost savings and potential environmental benefits due to reduced chemical usage. This type of system, in which the scene capture system, the scene analysis system, and the action mechanism are located on the same platform may be referred to herein as an “integrated system. ” Because the farm machine is moving across the field and the scene capture system, the scene analysis system, and the action mechanism are located close to one another on the same platform, the scene capture system and the scene analysis system must operate very quickly, sometimes in less than 100 ms, and it must do so deterministically, within a known time limit, to actuate the action mechanism, such as an herbicide applicator, to treat the detected weed once it has been detected. Achieving this performance while accurately detecting weeds and differentiating them from the desired crop in the field is challenging and requires substantial computational resources and careful tailoring of software. These requirements lead to higher costs, and necessary compromises in system performance due to the inherent timing requirements when compared to a system that is not required to operate so rapidly or deterministically, because a system that is free of such constraints has the freedom to select from processing techniques that can operate more slowly or with processing time constraints that are non-deterministic, as is typical of cloud-based or non-real-time edge-based processing architectures. In addition, the physical environment in which the farm machine operates may present performance challenges to the scene capture system. For example, environmental factors such as dust, clouds, sunlight or artificial lighting levels, and debris may degrade image quality or other sensed data or occlude the item of interest, such as weeds, from the scene capture system entirely. Further, other operational factors, such as vibration of the farm machine, platform motion and sway, can likewise degrade scenes captured by the scene capture system. Consequently, items of interest, such as a weed, might not be detected by the scene capture system and the scene analysis system on the moving platform.

### SUMMARY

Methods and systems for use in precision agriculture are described. The methods and systems described herein use a combination of low-cost, less accurate, and optional, positioning equipment and a low-cost cooperative scene (or image) capture system and scene analysis system to allow the scene capture system and the scene analysis system to interoperate more readily with an action mechanism. One or both of the scene capture system and the scene analysis system are physically separated from a platform carrying the action mechanism, as described further below. The scene capture system and the scene analysis system may be referred to herein as an off-platform scene capture system and an off-platform scene analysis system, respectively, since they are not on the platform or device incorporating the action mechanism, and the scenes captured by the off-platform scene capture system may be referred to as off-platform captured scenes. The off-platform scene capture system and the off-platform scene analysis system do not need to be temporally synchronized with the action mechanism, nor do the off-platform scene capture system and the off-platform scene analysis system need to operate in deterministic real-time, although they may. The described methods and systems can achieve the same or better level of effective accuracy and precision of action that the integrated system mentioned above would deliver using high precision positioning equipment. The methods and systems described herein can also achieve the same or better level of effective accuracy and precision of action compared to the integrated system mentioned above while also significantly mitigating the operational challenges inherent in systems that use the integrated system discussed above.

In an embodiment, an off-platform scene capture system contains sensing equipment, such as an imager, and gathers input data, such as a series of images (or scenes), that encompass an area of regard, such as a farm field. An off-platform scene analysis system receives the input data and performs processing to detect items of interest across the set of input data. The off-platform scene capture system and the off-platform scene analysis system are separate from the action mechanism, and may or may not be integrated with one another into the same platform or device. Since the input data set captured by the off-platform scene capture system covers the area of regard, the input data set also captures a record not only of the item(s) of interest but also the area surrounding the item(s) of interest. The input data could be a visual or non-visual band image, an elevation map, or other scene record that records the scene and the position of the item of interest within the scene. A scene may incorporate more than one item of interest with the scene. The off-platform scene capture system and the off-platform scene analysis system could be integrated together into the same platform or device or separated from one another in separate platforms or devices. For example, an unmanned aerial vehicle (or drone) or other aerial vehicle may incorporate a scene capture system that captures a series of scenes covering the area of regard, and the scenes could be uploaded to cloud processing or edge processing (i.e. a scene analysis system) for detection of the items of interest (or the scenes can be processed on the unmanned aerial vehicle), or the scenes can be captured by a ground-based device such as a ground robot and processed by the ground-based device or by cloud processing.

In an embodiment, the methods and systems described herein can make use of the observability of other features within a scene (e.g. a single image) when that scene also includes one or more detected items of interest. The methods and systems may establish the location of the item(s) of interest relative to other features in the scene or portion thereof. The location information may be relayed to the platform incorporating the action mechanism. Additionally, along with the relative location of the detected item(s) of interest in the scene, the captured scene itself, or a portion thereof, may also be transmitted to the platform incorporating the action mechanism. “Portion thereof” of the captured scene refers to any number of operations on the captured scene that may be undertaken, such as image cropping, downsampling, or transcoding, so long as representations of the item of interest and the representations of the sufficient number of other features are preserved in the portion relayed. The captured scene transmitted to the platform incorporating the action mechanism may be a set or list of feature descriptors and their relative locations in the captured scene, rather than or in addition to the actual captured scene. So the term “captured scene” that is transmitted to and stored on the platform incorporating the action mechanism includes one or more of the actual captured scene, a portion of the captured scene, a set or list of feature descriptors and their relative locations in the captured scene, or any other data that is a representation of the captured scene.

Optionally, the location of each captured scene, to the precision and accuracy that scene location information is available, may also be relayed to the platform incorporating the action mechanism. However, scene location is not required. Also, the plurality of observable features within the scene may be cataloged along with their relative locations within the scene, and thus the positions of the observable features relative to the items of interest in the scene can be determined, and this information is gathered by the scene analysis system. The observable features may be detected by a number of common methodologies. For example, Deep Learning techniques may detect and localize branches, small rocks, or crop residue, or more classical computer vision tools like SIFT/SURF and RANSAC may be used to locate and characterize features. Or the entire scene may be encoded for basic correlation-based scene matching.

On the platform incorporating the action mechanism, the off-platform captured scenes and possibly other information is received and stored. The platform's own scene capture systems (referred to as an on-platform scene capture system), such as cameras, integrated with the platform gather scene data as the platform moves across the field. An analysis/computation system on the platform (referred to as an on-platform scene analysis system) performs scene matching against the previously captured scenes containing items of interest that are stored on the platform. When the on-platform scene analysis system finds a match to a stored previously captured scene, it can then use the relative location of the detected item of interest within the matched scene and the platform-relative knowledge of the location of the scene capture system on the platform to establish the position of the detected item of interest relative to the platform. Since the position of the various elements of the action mechanism, for example chemical application nozzles, relative to the platform is known, the action mechanism can be actuated at the appropriate time and manner to effect an action against the detected item of interest. For example, when the item of interest is a weed, the platform's onboard sensors and systems are used to detect a scene matching a previously captured scene in which a weed is known to exist, then using the relative location of the weed in that previously captured scene to apply herbicide to the location where the weed has been detected.

The techniques described herein are much more robust in the presence of environmental and operational effects than the conventional practice of an integrated system described above, in which only the items of interest are detected and localized on the platform containing the action mechanism, because the scene matching process does not necessarily rely on the matching of a single item of interest (such as a single weed), but instead by the matching of multiple other features, such as rocks, plants, and crop debris as described earlier, that exist in a larger area surrounding the weed and lie within the fields of view of both the scene captured by the off-platform scene capture system and by the scene captured by the on-platform scene capture system on the action mechanism platform. Because the scene establishes the location of the item of interest relative to these other features, it is straightforward to establish the location of the item of interest by the relative position of the item of interest to the matched features in the scene. And because the orientation of the platform device relative to its own on-platform scene capture system is known, it is also straightforward to establish the position of the item of interest relative to the platform, and therefore relative to its action mechanism, for example an herbicide spray nozzle in the case of weed detection. In an embodiment, two or more other features may be detected in any scene, where feature centroid or similar information may be used to localize the item of interest by means of techniques such as image homographies or geometric transforms. Where only one other feature is detected, more advanced but standard feature characterization techniques that estimate feature orientation may be used or feature location without orientation combined with an image correlation process or Hough Transform matching could, for example, be used to establish the necessary position estimate of the item of interest.

While one or more of the other features present in the scene could be obscured, the probability that enough features will be obscured to prevent scene matching is very low, and the system will therefore perform more robustly than a system that has to match a single feature that could be very small or hard to distinguish, such as a single weed. Thus, so long as the off-platform scene capture system and the off-platform image analysis system have detected the item of interest, the action mechanism can still take action against the item of interest even if the item of interest is not detected by the on-platform scene capture system and on-platform scene analysis system so long as any of the plurality of other features in the image are still observable by the on-platform scene capture system and the on-platform scene analysis system. Many techniques, ranging from basic image correlation, to feature identification techniques, to deep-learning technologies can be used to robustly match scenes captured from different devices, even when a high percentage of the scene has been altered or is obscured. These techniques are generally more computationally efficient and robust than would be required if the full item of interest detection problem was performed on the action mechanism platform. Therefore, such an implementation is better suited to deployment on the action mechanism platform, where computational resources and deterministic processing requirements may be present.

Since it is possible for the methods and systems to be implemented using only the scene matching process, it is not strictly necessary for any of the platforms carrying the off-platform scene capture system, the off-platform scene analysis system, or the action mechanisms to have awareness of their absolute or relative location for the methods and systems to work. Therefore, the need for very high precision positioning equipment on the platforms is eliminated. However, as a practical matter, nearly all relevant platforms incorporate at least a basic localization capability, such as a standard GNSS receiver. So in another embodiment, any available positioning information may be used that is available on the scenes detected by all platforms to filter the candidate scenes to be matched, based on possible locations of each scene and the known location of the action mechanisms. This reduces the search space required to perform the matching function, which allows for further optimization of the methods and systems. For example, if a basic system accurate to within 15 meters is used on the platforms and the scene data is tagged with this imagery, then when performing scene matching, there is no need to consider matching scenes that are known to be observed more than 30 meters away. In fact, the systems and methods described herein have utility anywhere along the continuum from no localization accuracy whatsoever on the platforms to perfect localization accuracy on the platforms, because the superior detection robustness of the described methods and systems remains in all cases; the scene matching search space simply becomes larger or smaller.

As described in further detail below, a precision agriculture machine captures current scenes of an agricultural field using one or more on-platform scene capture systems on the precision agriculture machine while the machine moves across the field. The captured current scenes are compared to previously captured scenes of the field, captured by an off-platform scene analysis system, that are stored on the machine. When a match is determined between a captured current scene and a previously captured scene, the machine is used to take an action against an item of interest that is visible in the captured current scene. The determination of a match can be achieved by matching a number of discrete, individual features that are present in the captured current scene as well as the previously captured scenes. The features can be any features that can be individually identified in the captured scenes. In an embodiment, at least one of the features is the item of interest against which action is to be taken such as, but not limited to, a weed.

### DRAWINGS

FIG. 1 illustrates an example of a precision agriculture method described herein.

FIG. 2 illustrates an example of an agricultural field and an off-platform scene capture system.

FIG. 3 depicts an example of a scene captured by the off-platform scene capture system that includes an item of interest and additional detected features.

FIG. 4 depicts determining the relative position of the item of interest and the additional features in a scene.

FIG. 5 schematically depicts a precision agriculture machine described herein.

FIG. 6 depicts a specific example of a precision agriculture machine taking action against an item of interest in the form of a weed.

### DETAILED DESCRIPTION

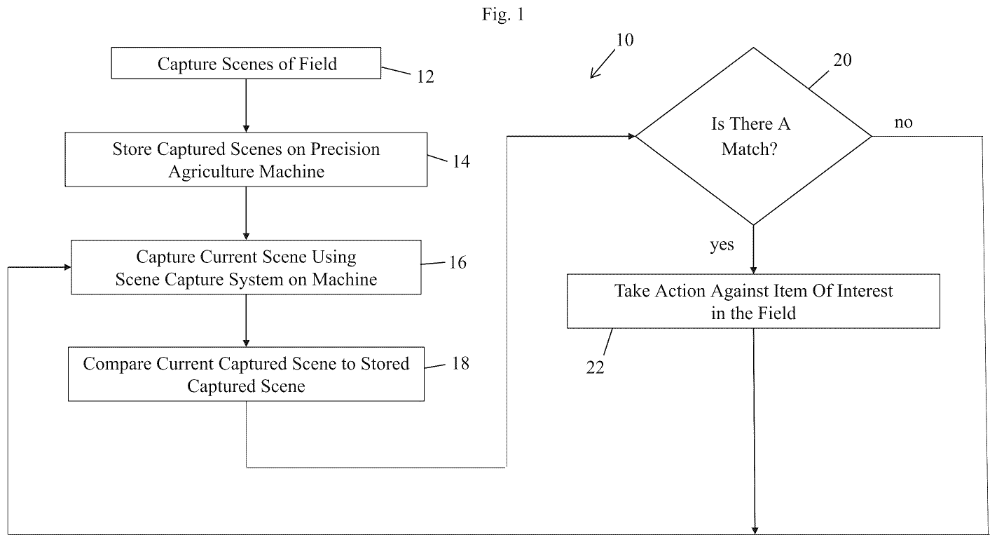

FIG. 1 illustrates an example of a precision agriculture method 10 described herein. As used herein, the word “step” can include a single action that forms the step or multiple actions that form the step. In step 12, scenes of an agricultural field are captured by an off-platform scene capture system that is separate from a precision agriculture machine. The captured scenes may be analyzed by an off-platform scene analysis system that detects one or more items of interest in the captured scenes and detects one or more other features in the captured scenes. In step 14, the captured scenes are then stored on the precision agriculture machine. In step 16, a scene capture system on the precision agriculture machine is used to capture a current scene of a portion of the agriculture field while the precision agriculture machine is moving across the agricultural field. In step 18, the captured current scene is then compared to the stored captured scenes. In step 20, if there is a match between the captured current scene and one of the stored captured scenes, action is taken in step 22 by the precision agriculture machine against the item of interest in the agricultural field. Alternatively, if there is not a match in step 20, the method 10 can return to step 16 and the method repeats from there.

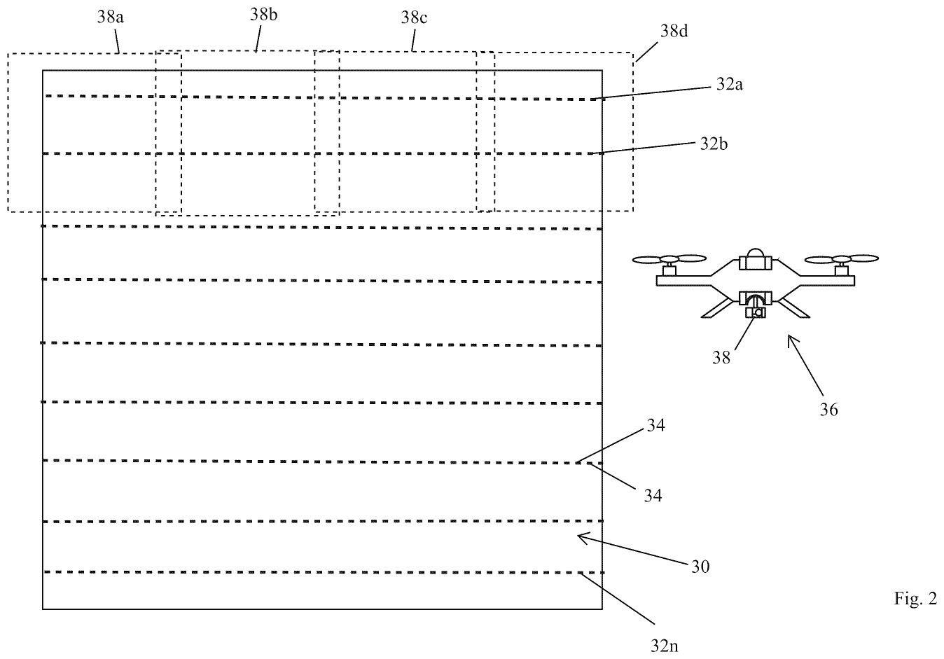

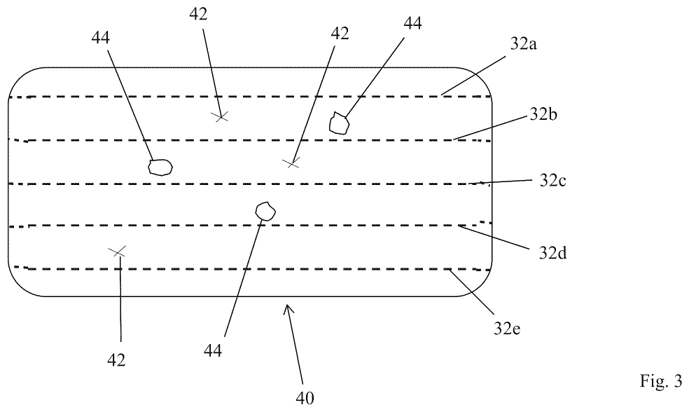

Referring to FIG. 1 along with FIGS. 2-3, an agricultural field 30 is illustrated. The field 30 is depicted as growing crops in a number of crop rows 32a, 32b . . . 32n. The crops can be any type of crops grown in an agricultural field. For example, the crops can be annually planted and harvested crops including, but not limited to, corn, soy beans, cotton, wheat, or other annual crops; permanent crops which refers to crops grown on plants which last for many growing seasons rather than being replanted after each harvest including, but not limited to, grape vines which grow grapes, trees or plants used to grow fruits such as peaches, pears, apples, oranges, olives and the like, and many other permanent crops; and any other type of crops. Each row includes individual plants 34 spaced from one another in the row.

In step 12 in FIG. 1, scenes of the field 30 are captured by an off-platform scene capture system 36. At least two scenes are captured, or there can be hundreds or thousands of scenes that are captured. FIG. 2 depicts the scene capture system 36 as an unmanned aerial vehicle (a.k. a. a drone) that is flown over the field 30 together with a scene capture device 38 such as a camera. Alternatively, the detection mechanism 36 can be an aircraft (manned or unmanned), a balloon, a satellite, a ground robot, a tractor or other agriculture vehicle, or other platform suitable for carrying a scene capture device 38 such as a camera for capturing scenes as described herein. In an embodiment, the off-platform scene capture system may be considered as being just the camera 38. The camera 38 captures scenes (also referred to as images) of individual sections of the field 30. The scenes can be in a visual band or a non-visual band. The captured scenes cover some or all of the field 30. FIG. 2 depicts examples of the fields of view 38a, 38b, 38c, 38d of individual captured scenes. The fields of view 38a, 38b, 38c, 38d overlap one another to ensure that the captured scenes provide complete coverage of the desired area of the field 30.

FIG. 3 depicts a schematic example of a captured scene 40. The scene 40 includes one or more of the crop rows, one or more items of interest 42, and other features 44. The illustrated example depicts crop rows 32a, 32b, 32c, 32d, 32e, but the scene 40 can include more or less crop rows. The item(s) of interest 42 is any item in the field that one wishes to take action against to improve the field 30. The item(s) of interest 42 can include, but are not limited to, a weed, an individual plant that has been impacted by insect pressure, an individual plant that has been impacted by fungal pressure, an individual plant that is suffering from nutrient deficiency, or any other identifiable item in the field 30. The item of interest 42 can also be an area or region of the field 30 that is unusually wet or unusually dry, crops that are planted with a spatial density that differs from other plants in the field, an area or region of the field 30 where the soil is suffering from nutrient deficiency, or any other observable item or region that action can be taken against to improve the field 30 and ultimately the crop yield.

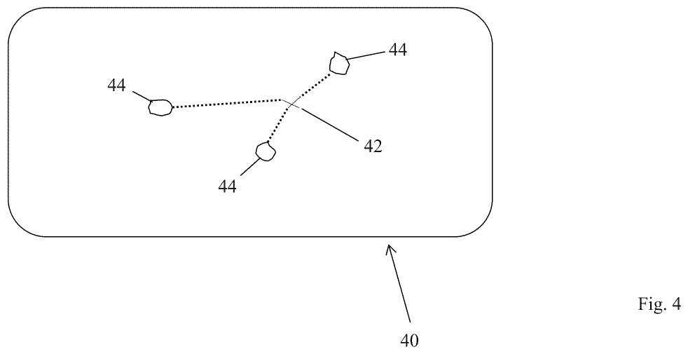

The other features 44 can be any identifiable features in the scene 40. In an embodiment, the features 44 may be different than the item(s) of interest 42. Examples of features 44 include, but are not limited to, rocks, unique individual plants in one or more crop rows, branches, crop residue, weeds that differ from the item(s) of interest 42, cracks in the soil, stem and plant tissue, objects (such as QR codes, visual markers and other man-made objects) intentionally placed in the field to act as fiducial markers, and other features. In an embodiment, the features 44 are features that are located between the crop rows. However, one or more of the features 44 may be individual plants in one or more of the crop rows. Referring to FIG. 4, the relative position of the item of interest 42 with respect to two or more of the other features 44 in the scene 40 determines the location of the item of interest 42 in the scene 40.

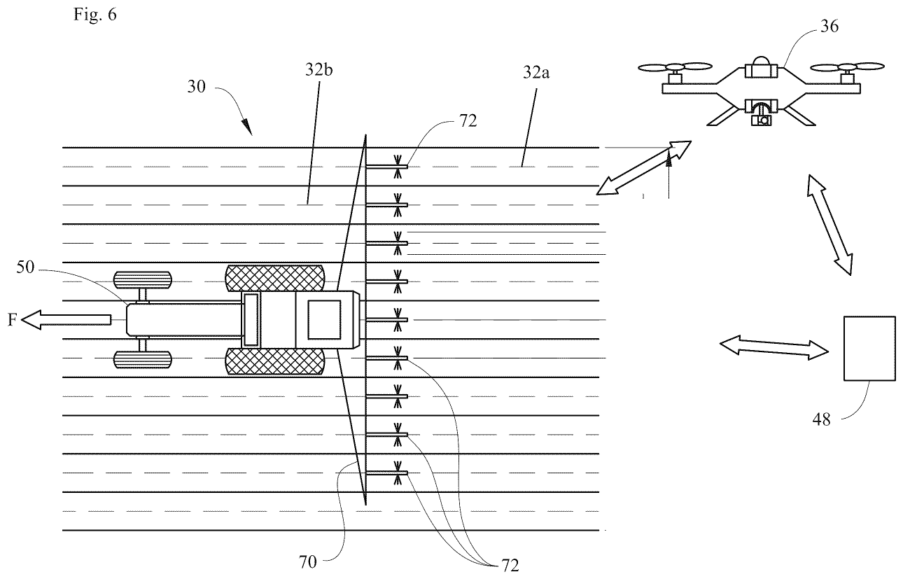

The off-platform captured scenes are provided to an off-platform scene analysis system that processes the scenes to detect the item(s) of interest 42 and the other features 44 in each captured scene. In an embodiment, for each scene, the relative positions of the item(s) of interest 42 and the other features 44 may also be determined. The item(s) of interest 42 and the other features 44 may be detected using any suitable recognition methodologies which are known in the art. For example, Deep Learning techniques may detect and localize the item of interest and the other features; or computer vision tools like SIFT/SURF and RANSAC may be used. Or the scene or a portion thereof may be encoded for basic correlation-based scene matching. The off-platform scene analysis system may generate a set or list of feature descriptors and their relative locations in the captured scene. The off-platform scene analysis system that processes the scenes may be incorporated onto the off-platform scene capture system 36 or may be separate from the off-platform scene capture system 36. For example, the off-platform scene analysis system may be incorporated onto the UAV in FIG. 2, incorporated into a ground control station 48 (FIG. 6) that controls operation of the UAV in FIG. 2, or the off-platform scene analysis system may be cloud-based with the captured scenes uploaded to the cloud for processing. In an embodiment, the scene analysis system for analyzing the off-platform captured scenes may be incorporated onto the precision agriculture machine.

In one embodiment, the technique used for the precision agriculture machine to take action against an item of interest may use image correlation to match a currently captured scene with a previously captured, off-platform captured scene captured by the off-platform scene capture system. The presence of features that are commonly found in farm fields, such as cracks in the soil and/or arrangements of a plurality of elements of crop residue on the ground, such as stem and plant tissue, are well-suited to matching using image correlation. Image correlation as a matching technique may have special interest because it is a mature technology that is easily adapted for real-time implementation on the precision agriculture machine.

Referring back to FIG. 1, in step 14, some or all of the captured scenes (or portions of the scenes) are stored on the precision agriculture machine. The captured scenes transmitted to and stored on the precision agriculture machine may be a set or list of feature descriptors and their relative locations in the captured scenes, rather than or in addition to the actual captured scenes. So the term “captured scene” that is transmitted to and stored on the precision agriculture machine includes one or more of the actual captured scenes, portions of the captured scenes, a set or list of feature descriptors and their relative locations in the captured scenes, or any other data that is a representation of the captured scenes. A “portion” of the scene refers to any number of operations on the scene that may be undertaken, such as image cropping, downsampling, transcoding, so long as representations of the item of interest and the representations of the sufficient number of other features are preserved in the portion stored on the precision agriculture machine.

In an optional embodiment, for each off-platform captured scene, the location of the item(s) of interest relative to the other features in the captured scene may also be stored on the precision agriculture machine. In another optional embodiment, the location or coordinates of each captured scene, to the precision and accuracy that scene location information is available, may also be provided to the precision agriculture machine with each captured scene. The location information is available from a navigation mechanism on the scene capture system 36. The navigation mechanism can be any navigation mechanism that is suitable for providing location/position information as each scene is captured. For example, the navigation mechanism can be a GNSS receiver.

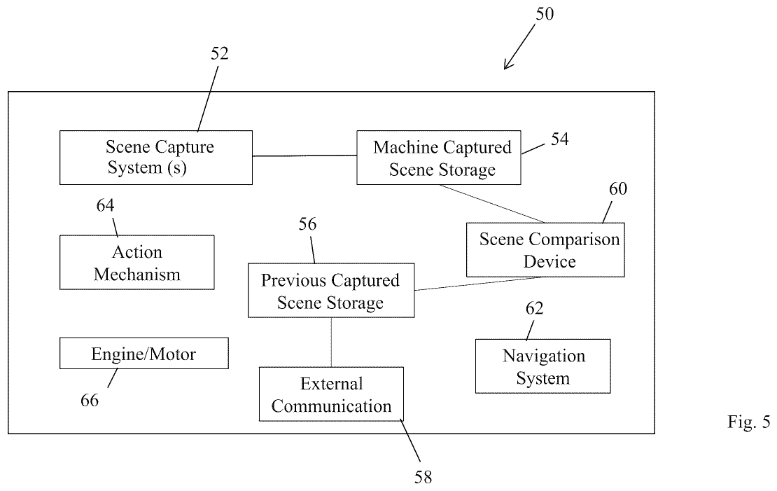

FIG. 5 schematically depicts an example of a precision agriculture machine 50 that is configured to take action against an item of interest. The machine 50 can be any platform or chassis used in precision agriculture. Examples include, but are not limited to, a tractor, a sprayer, a UAV (or drone), a manned or unmanned aircraft, a ground robot, and others. The machine 50 can include one or more on-platform scene capture systems 52, which can be, for example, one or more cameras mounted on the machine 50 that capture(s) live or current images (or on-platform captured images), in a visual or non-visual band, of the field 30. The scenes captured by the scene capture system(s) 52 are stored in a data storage device 54 on the machine 50.

The machine 50 can further include a data storage device 56 that stores the off-platform previously captured scenes captured by the off-platform scene capture system 36 and//or stores the data generated by the off-platform scene analysis system. The previously captured scenes can be stored on the machine 50 via an external communication mechanism 58 such as a data port or a wireless communication interface through which the previously captured scenes are input to the machine 50. The storage 54, 56 may be separate from one another, or part of the same storage device. The machine 50 may also include a scene comparison device 60 (or on-platform scene analysis system), a navigation system 62, an action mechanism 64, and an engine/motor 66. The current captured scenes captured by the scene capture system(s) 52 may also comprise terrain elevation maps, and the previously captured scenes may comprise collections of terrain elevation data measurements.

The scene comparison device 60 is configured to compare a live or current scene (or a portion thereof) captured by the scene capture system(s) 52 as the machine 50 travels across (e.g. within, by or above) the field to one or more of the previously captured scenes stored in the storage 56 to determine if there is a match between the live/current captured scene and one of the previously captured scenes. The scene comparison device 60 may be a computerized scene comparison system that includes a computation system that performs scene matching of the current/live scene against the previously captured scenes containing the item(s) of interest. Any technique for scene matching can be used. In one embodiment, feature matching can be used. In another embodiment, image correlation can be used. The presence of features that are found in farm fields, such as cracks in the soil, rocks, and/or arrangements of a plurality of elements of crop residue on the ground, such as stem and plant tissue, are well-suited to scene matching using image correlation. In an embodiment, a list of features and descriptors can be generated from the current captured scene and compared to a stored list of features and descriptors generated from the off-platform captured scenes. In an embodiment, the off-platform captured scenes, or portions thereof, can be stored, and correlation used to match the current captured scene to one of the off-platform captured scenes.

When the comparison device 60 finds a match to one of the previously captured scenes, the comparison device 60 can then use the relative location of the detected item(s) of interest within the matched current/live scene and the machine platform-relative knowledge of the location of the scene capture system 52 on the machine 50 to establish the position of the detected item of interest relative to the machine 50. Further, the position of the action mechanism 64 relative to the machine is known and can be actuated at the appropriate time and manner to effect an action against the detected item of interest. For example, if the item of interest is a weed, instead of the machine's 50 onboard sensors and systems looking for a weed in the sensed data, the machine 50 is used to detect a scene that matches a previously captured scene in which a weed is known to exist, and then the relative location of the weed in that scene can be used to apply herbicide to the location where the weed has been detected.

This scene matching technique is more robust in the presence of the environmental and operational effects described above because scene matching does not necessarily rely on the matching of a single item of interest (such as a single weed), but by matching of multiple other features. Features may include visibly discrete objects such as rocks, plants, and crop debris as described earlier, that exist in a larger area near the item of interest. Features may also include features as defined in the art in computer vision, such as general points, corners, ridges, blobs, and other elements detected by common feature detection algorithms. Because the scene establishes the location of the item of interest relative to these other features, it is straightforward to establish the location of the item of interest by the relative position of the item of interest to the matched features in the current/live scene. In addition, because the orientation of the machine relative to its own scene capture system 52 is known, it is also straightforward to establish the position of the item of interest relative to the machine 50, and therefore relative to the action mechanism 64. When two or more other features are detected in any previously captured scene, feature centroid or similar information is all that is required to localize the item of interest. Where only one other feature in the previously captured scene is detected, feature orientation or feature location combined with an image correlation process or Hough Transform matching could, for example, be used to establish the necessary position estimate of the item of interest.

While one or more of the other features present in the current/live captured scene could be obscured by the hazards noted above, the probability that enough features will be obscured to prevent scene matching is very low, and the system will therefore perform more robustly than a system that has to match a single feature that could be very small or hard to distinguish, such as a single small weed. If the item of interest is detected, the action mechanism 64 will still perform its action on the item of interest even if the item of interest is not detected in the current/live scene by the scene capture system 52 so long as any of the plurality of other features in the current/live scene are still observable. Many techniques, ranging from basic image correlation, including rotation-invariant correlation, to feature identification techniques, to deep-learning technologies, can be used to match scenes captured from different devices (i.e. the device on the scene capture system 36 and the scene capture system 52 on the machine 50), even when a high percentage of the scene has been altered or is obscured. These techniques are generally more computationally efficient and robust than would be required if the full item of interest detection problem was performed on the machine 50.

Since it is possible for the machine 50 to perform an action against the item of interest by actuating the action mechanism 64 using only the scene matching process, it is not strictly necessary for the scene capture system 36 or the machine 50 to have awareness of their absolute or relative location for the system to work. Therefore, the need for very high precision positioning equipment on both platforms is eliminated. However, many platforms such as a UAV and agriculture equipment incorporate at least a basic localization capability, such as a standard GNSS receiver. So in one embodiment, any available positioning information that is available for the scenes can be used to filter the candidate scenes for the current/live scene to be matched against, based on possible locations of each scene and the known location of the machine 50. This reduces the search space required to perform the matching function, which allows for further optimization of the system. For example, if a basic system accurate to within 15 meters is used on both the scene capture system 36 and the machine 50 and the scene data is tagged with this imagery, then when performing scene matching, there is no need to consider matching scenes that are known to be observed more than 30 meters away. The matching process described herein can be implemented anywhere along the continuum from no localization accuracy whatsoever on either platform 36, 50 to perfect localization accuracy on both platforms 36, 50.

Returning to FIG. 5, the navigation system 62 (if present) can be any navigation mechanism that is suitable for providing location/position information as each current/live scene is captured by the scene capture system(s) 52. For example, the navigation mechanism can be a GNSS receiver.

The action mechanism 64 can be any mechanism that is suitable for taking action against the item of interest observed in the field. The term “taking action” means to perform a physical action on the item of interest that impacts the item of interest. For example, the action mechanism 64 can be one or more spray nozzles that are configured to spray a product such as an herbicide, a pesticide/insecticide, a fungicide, a fertilizer, adjuvant, surfactant, or other sprayable product on or adjacent to the item of interest. The action mechanism can include an energy applicator that is configured to apply energy to the item of interest using the energy applicator. For example, the energy applicator can be a laser that applies laser energy to the item of interest, a voltage applicator that applies a voltage to the item of interest, a fire source that applies fire to the item of interest, an oil source that applies hot oil to the item of interest, or other applications of energy sufficient to, in the case of a weed, destroy the weed. The action mechanism 64 may also comprise a mechanical destruction system that removes, cuts or destroys the item of interest using the mechanical destruction system. For example, the mechanical destruction system may be a mechanical weed destruction system for destroying weeds. Other actions by the action mechanism 64 are possible.

FIG. 6 illustrates an example of the system including the off-platform scene capture system 36, a ground control station 48 which may include or comprise the off-platform scene analysis system if not incorporated onto the scene capture system 36, and the machine 50 in the field 30. Assuming the items of interest in the field are weeds, the machine 50 is depicted as a tractor with a sprayer 70 having a plurality of spray nozzles 72. The sprayer 70 may be a self-propelled sprayer or a separate component towed behind a tractor or other farm machine that provides motive power. One of the scene capture systems 52 can be associated with each spray nozzle 72. As the tractor travels across the field 30, the scene matching described herein can be used for each scene capture system 52 to trigger the corresponding spray nozzle 72 to apply a chemical to individual weeds as the tractor is traveling. In this instance, the machine 50 together with the sprayer 70 may be considered the action mechanism 64, or just the sprayer 70 may be considered the action mechanism 64, or an individual one of the spray nozzles 72 may be considered the action mechanism 64. The sprayer 70 may be a herbicide sprayer.

The engine/motor 66 is configured to propel the machine 50. The engine/motor 66 may be an internal combustion engine using a fuel such as gasoline or diesel, or the engine/motor 66 may be an electric motor powered by one or more batteries. The engine/motor 66 may be connected to and drive wheels and/or tracks that support the machine 50 on the ground and that propel the machine 50.

The techniques described herein may be employed at any time in the growing season of the crops. In an embodiment, the techniques described herein are utilized early enough in the growing season of certain crops prior to a canopy of the crops closing and preventing, in the captured scenes, observation of the items of interest and the features in the case of ground-based features. The current/live scene(s) should be captured by the scene capture system(s) 52 within a reasonable time-frame after capture of the off-platform previously captured scenes by the scene capture system 36 to reduce the chance that a scene may change (for example due to wind causing the features or even the item of interest moving, or due to the item of interest growing significantly since the off-platform captured scene, etc.). In an embodiment, the capture of the current/live scene(s) occurs within 7 days of less of capture of the off-platform previously captured scenes. In another embodiment, the capture of the current/live scene(s) occurs within 2 days of less of capture of the off-platform previously captured scenes. In still another embodiment, the capture of the current/live scene(s) occurs within 1 day of less of capture of the off-platform previously captured scenes.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A precision agriculture method, comprising:
capturing a current scene of an agricultural field using an on-platform scene capture system mounted on a precision agriculture machine located in the agricultural field, the captured current scene including at least one item of interest, and the precision agriculture machine includes previously captured scenes of the agricultural field that are stored on the precision agriculture machine;
providing the captured current scene to a computerized scene comparison system on the precision agriculture machine, and using the computerized scene comparison system to compare the captured current scene to the previously captured scenes of the agricultural field to determine a match between the captured current scene and one of the previously captured scenes; and
when a match is determined, using the precision agriculture machine to take an action that impacts the at least one item of interest in the agricultural field.

2. The precision agriculture method of claim 1, wherein the on-platform scene capture system comprises a camera, and the captured current scene and the previously captured scenes are images.

3. The precision agriculture method of claim 1, wherein the previously captured scenes that are stored on the precision agriculture machine comprise one or more of: entire captured scenes; portions of captured scenes; a set or list of feature descriptors and their relative locations in captured scenes; or data that is a representation of captured scenes.

4. The precision agriculture method of claim 1, wherein the captured current scene includes at least two additional features, and wherein comparing the captured current scene to the previously captured scenes of the agricultural field comprises locating the at least two additional features in at least one of the previously captured scenes.

5. The precision agriculture method of claim 1, wherein comparing the captured current scene to the previously captured scenes of the agricultural field comprises: comparing a list of feature descriptors and feature locations of features in the captured scene to a list of feature descriptors and feature locations of features in the previously captured scenes.

6. The precision agriculture method of claim 1, wherein the at least one item of interest comprises at least one weed, the precision agriculture machine comprises a herbicide sprayer, and the action comprises spraying the at least one weed with herbicide.

7. The precision agriculture method of claim 1, wherein the at least one item of interest comprises at least one weed, the precision agriculture machine comprises an energy applicator, and the action comprises applying energy to the at least one weed using the energy applicator.

8. The precision agriculture method of claim 7, wherein the energy applicator comprises:
a laser and the action comprises applying laser energy to the at least one weed; a voltage applicator and the action comprises applying a voltage to the at least one weed; a fire source and the action comprises applying fire to the at least one weed; or an oil source and the action comprises applying oil to the at least one weed.

9. The precision agriculture method of claim 1, wherein the at least one item of interest comprises at least one weed, the precision agriculture machine comprises a mechanical weed destruction system, and the action comprises removing or destroying the at least one weed using the mechanical weed destruction system.

10. The precision agriculture method of claim 1, further comprising capturing the previously captured scenes using an off-platform scene capture system that is separate from the precision agriculture machine, and storing the previously captured scenes on the precision agriculture machine.

11. The precision agriculture method of claim 10, wherein the off-platform scene capture system is mounted on an unmanned aerial vehicle.

12. The precision agriculture method of claim 1, wherein the capturing of the current scene occurs within 7 days or less of capture of the previously captured scenes.

13. The precision agriculture method of claim 12, wherein the capturing of the current scene occurs within 2 days or less of capture of the previously captured scenes.

14. The precision agriculture method of claim 4, further comprising determining a relative position of the at least one item of interest in the at least one previously captured scene and the at least two additional features in the at least one previously captured scene, and providing the relative positions to the precision agriculture machine prior to capturing the current scene.

15. The precision agriculture method of claim 1, further comprising providing positional information of each previously captured scene to the precision agriculture machine.

16. The precision agriculture method of claim 1, further comprising providing positional information of the captured current scene to the precision agriculture machine.

17. The precision agriculture method of claim 11, further comprising detecting, in each of the previously captured scenes, the at least one item of interest and at least one additional feature using an off-platform captured scene analysis system on the unmanned aerial vehicle.

18. The precision agriculture method of claim 11, further comprising detecting, in each of the previously captured scenes, the at least one item of interest and at least one additional feature using an off-platform captured scene analysis system separate from the unmanned aerial vehicle and separate from the precision agriculture machine.
